(19) United States
(12) Patent Application Publication
(10) Pub. No.: US 2011/0043466 A1
(43) Pub. Date: Feb. 24, 2011

(54) TOUCH SCREEN LIQUID CRYSTAL DISPLAY DEVICE

(75) Inventors: Ji Hun KIM, Daejeon-si (KR); Woong Jin OH, Daejeon-si (KR); An Young KIM, Daejeon-si (KR); Joon Ho NA, Daejeon-si (KR); Dae Seong KIM, Daejeon-si (KR)

Correspondence Address: Jae Y. Park, Kile Park Goekjian Reed & McManus PLLC, 1200 New Hampshire Ave. NW, Suite 570, Washington, DC, 20036, US

(73) Assignee: SILICON WORKS CO., LTD, Daejeon-si (KR)

(21) Appl. No.: 12/846,561

(22) Filed: Jul. 29, 2010

(30) Foreign Application Priority Data
Aug. 19, 2009 (KR) 10-2009-0076798

(51) Int. Cl. G06F 3/041

(52) U.S. Cl. 345/173

(57) ABSTRACT

An touch screen liquid crystal display device includes a panel driving circuit including a gate driving block, a data driving block, and a signal control block and a liquid crystal module that stores data in data pixels through a data pixel line, to which the data pixels are connected, in response to a data signal applied from the data driving block, and reads data through a read pixel line to which read pixels are connected. The read pixels are connected to the data pixels through a share line.

### BACKGROUND OF THE INVENTION

1. Field of the Invention

The present invention relates to a touch screen liquid crystal display device, and more particularly, to a touch screen liquid crystal display device which is designed to store data in pixels and read touch information by using a liquid crystal module with a structure of sharing a data pixel line and a read pixel line.

2. Description of the Related Art

With the recent development and popularization of a graphic user interface (hereinafter, referred to as a “GUI”) system, a touch screen liquid crystal display device having a simple input interface has been extensively used. The touch screen liquid crystal display device is an input device substituting for a keyboard and a mouse, in which if a user directly touches a touch panel mounted on a liquid crystal display panel by fingers, a desired operation is performed.

The touch screen liquid crystal display device allows a user to complete a business process in GUI environment such as a window operating system, which can be extensively used for an office automation field, a game application field, a mobile device field and the like.

Such a touch screen liquid crystal display device is classified into a resistive type, a capacitive type, an infrared type, an acoustic type, an electromagnetic type and the like. Recently, research into an integral type capacitive touch screen liquid crystal display device provided with a liquid crystal display panel having functions of a touch panel has been actively conducted in order to reduce the thickness of a touch screen liquid crystal display device.

The above-described touch screen liquid crystal display device basically includes a liquid crystal panel for displaying image information, a touch panel attached to the liquid crystal panel, a controller, a source driver IC and the like.

The capacitive touch screen liquid crystal display device has a configuration in which a plurality of polar plates corresponding to input keys are arranged on a substrate while being spaced apart from one another at a predetermined interval, and a voltage is applied to the polar plates. The capacitive touch screen liquid crystal display device operates in such a manner that when a person's finger touches a polar plate, it is determined that the polar plate has been selected by detecting parasitic capacitance according to dielectric constant between the finger and the polar plate, and a determined input signal is transmitted to a central processing unit (CPU) of a terminal, so that input corresponding to the input signal is performed.

FIG. 1 is a circuit diagram illustrating the structure of a liquid crystal module of a capacitive touch screen liquid crystal display device in accordance with the prior art.

Referring to FIG. 1, the liquid crystal module 100 of the capacitive touch screen liquid crystal display device in accordance with the prior art includes a plurality of gate lines G₁ to G₃ formed on a substrate to transmit a gate signal, a plurality of data pixel lines V_{DATA}_{_{—}}₁ to V_{DATA}_{_{—}}₃ for transmitting a data signal, and a read pixel line R_{READ1} for reading stored information. It can be understood that the data pixel lines V_{DATA}_{_{—}}₁ to V_{DATA}_{_{—}}₃ are separated from the read pixel line R_{READ1}.

As shown in FIG. 1, in the liquid crystal module 100 of the conventional capacitive touch screen liquid crystal display device, since the data pixel lines are separated from the read pixel line, a channel output load of a data driving circuit SD-IC is uniform over all channels, so that an output waveform is also uniform. However, the liquid crystal module with the above structure is problematic in that aperture ratios of RGB data pixels are reduced as the number of read pixels is increased, and a large-sized liquid crystal panel is required.

### SUMMARY OF THE INVENTION

Accordingly, the present invention has been made in an effort to solve the problems occurring in the related art, and an object of the present invention is to provide a touch screen liquid crystal display device designed to store data in pixels and read touch information by using a liquid crystal module with a structure of sharing a data pixel line and a read pixel line.

Another object of the present invention is to provide a touch screen liquid crystal display device capable of reducing variation of output waveforms of a data line and a share line by compensating for delay occurring in the share line in a liquid crystal module with a structure of sharing a data pixel line and a read pixel line.

In order to achieve the above object, according to one aspect of the present invention, there is provided a touch screen liquid crystal display device including: a panel driving circuit including a gate driving block, a data driving block, and a signal control block; and a liquid crystal module that stores data in data pixels through a data pixel line, to which the data pixels are connected, in response to a data signal applied from the data driving block, and reads data through a read pixel line to which read pixels are connected, wherein the read pixels are connected to the data pixels through a share line.

According to a touch screen liquid crystal display device in accordance with the present invention, aperture ratios of data pixels can be ensured, even if a small-sized liquid crystal panel is used, by using a liquid crystal module with a structure of sharing data pixel lines and read pixel lines.

Furthermore, according to a touch screen liquid crystal display device in accordance with the present invention, a bias current supplied to an output buffer for driving a share line is increased or the size of a multiplexer connected to the output buffer of the share line is increased, so that delay occurring in the share line is compensated for, resulting in the reduction in variation of output waveforms.

### BRIEF DESCRIPTION OF THE DRAWINGS

The above objects, and other features and advantages of the present invention will become more apparent after a reading of the following detailed description taken in conjunction with the drawings, in which:

FIG. 1 is a circuit diagram illustrating the structure of a liquid crystal module of a capacitive touch screen liquid crystal display device in accordance with the prior art;

FIG. 2 is a circuit diagram illustrating the structure of a liquid crystal module of a touch screen liquid crystal display device in accordance with the present invention;

FIG. 3A is a circuit diagram illustrating the structure of a liquid crystal module and a data driving block of a touch screen liquid crystal display device in accordance with the present invention; and

FIG. 3B is a diagram illustrating timing of a data pixel line and a share line of a touch screen liquid crystal display device in accordance with the present invention.

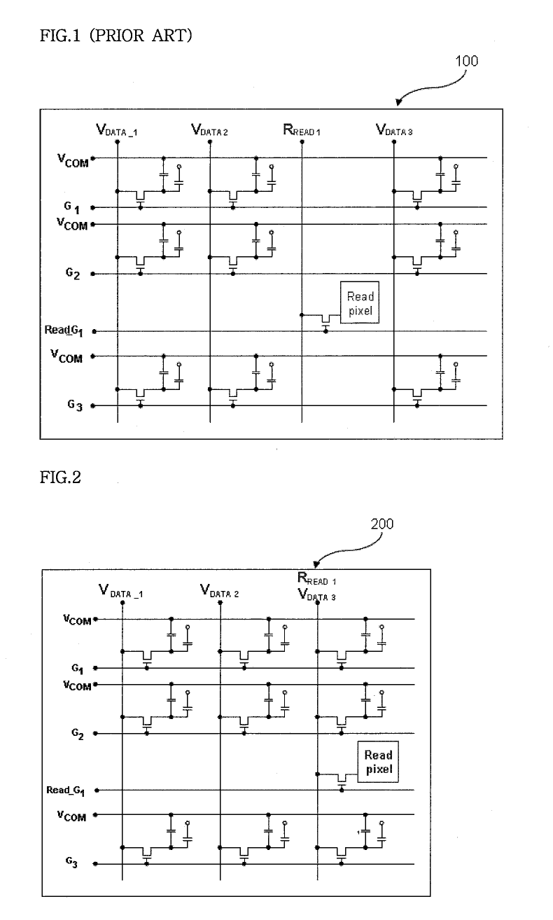

### DETAILED DESCRIPTION OF PREFERRED EMBODIMENTS

Reference will now be made in greater detail to a preferred embodiment of the present invention, an example of which is illustrated in the accompanying drawings.

A touch screen liquid crystal display device in accordance with the present invention includes a panel driving circuit and a liquid crystal module. The panel driving circuit includes a gate driving block, a data driving block, and a signal control block. Since the gate driving block and the signal control block have the same configurations as those of a gate driving block and a signal control block in accordance with the prior art, except for the data driving block, detailed description thereof will be omitted.

FIG. 2 is a circuit diagram illustrating the structure of a liquid crystal module of a touch screen liquid crystal display device in accordance with the present invention.

As shown in FIG. 2, the liquid crystal module 200 of the capacitive touch screen liquid crystal display device in accordance with the present invention includes a plurality of gate lines G₁ to G₃ formed on a substrate to transmit a gate signal, a plurality of data pixel lines V_{DATA}_{_{—}}₁ to V_{DATA}_{_{—}}₃ for transmitting a data signal, and a read pixel line R_{READ1} for reading stored information. It can be understood that the read pixel line R_{READ1} and the data pixel line V_{DATA}_{_{—}}₃ are shared.

By the use of the liquid crystal module with a structure of sharing the data pixel line and the read pixel line as described above, the aperture ratios of RGB data pixels can be increased.

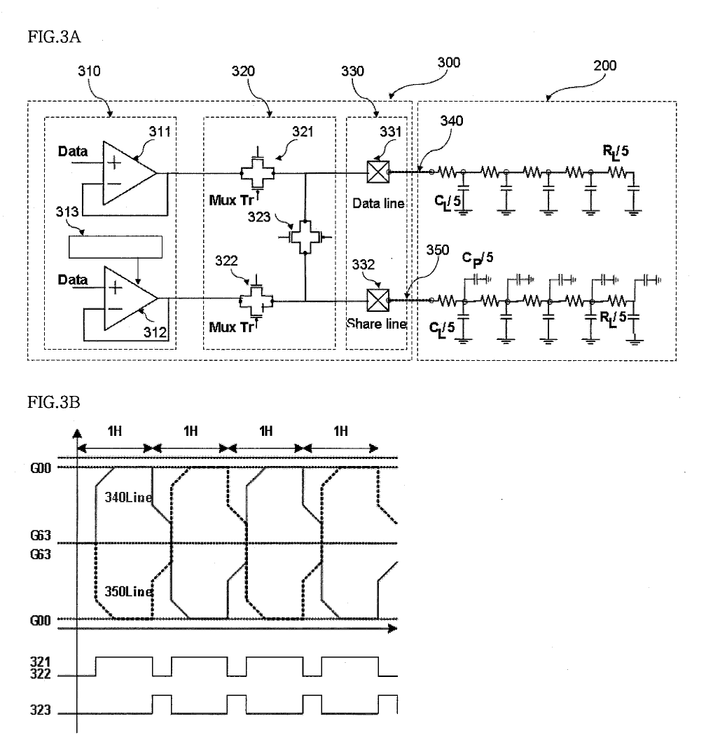

FIG. 3A is a circuit diagram illustrating the structure of the liquid crystal module and the data driving block of the touch screen liquid crystal display device in accordance with the present invention, and FIG. 3B is a diagram illustrating timing of the data pixel line and the share line of the touch screen liquid crystal display device in accordance with the present invention.

As shown in FIG. 3A, the data driving block 300 of the touch screen liquid crystal display device in accordance with the present invention includes an output buffer unit 310, a multiplexer unit 320 and a pad unit 330.

The output buffer unit 310 outputs a data signal for driving the liquid crystal module 200, and includes a data line output buffer 311 and a share line output buffer 312. The data line output buffer 311 outputs the data signal to a data pixel line 340 and the share line output buffer 312 outputs the data signal to a share line 350.

The multiplexer unit 320 selects one of output signals of the output buffer unit 310 and transmits the selected one to the liquid crystal module 200. The multiplexer unit 320 includes a data line multiplexer 321 and a share line multiplexer 322. The data line multiplexer 321 selects and transmits one of output signals of the data line output buffer 311, and the share line multiplexer 322 selects and transmits one of output signals of the share line output buffer 312.

It is preferable that the multiplexer unit 320 further includes a transmitter 323 which is connected to an output terminal of the data line multiplexer 321 and an output terminal of the share line multiplexer 322.

As shown in FIG. 3B, at the time of data transmission, a high voltage is applied to the data pixel line 340 and a low voltage is applied to the share line 350. Then, before subsequent data is transmitted, the connection of the transmitter 323 is made, so that charges of the data pixel line 340 and the share line 350 are shared, resulting in the reduction in current consumption.

The pad unit 330 includes a data line pad 331 connected to the data pixel line 340 of the liquid crystal module 200 and a share line pad 332 connected to the share line 350.

As shown in FIG. 3A, in the structure of sharing the data pixel line and the read pixel line, since parasitic capacitors Cp and parasitic resistances are additionally increased in the share line 350 differently from the data pixel line 340, delay phenomenon occurs as compared with the data pixel line 340.

Therefore, if the same output buffer is used when driving the data pixel line 340 and the share line 350, variation of output waveforms occurs, thereby causing the difference of an image. In this regard, it is required to provide a technology capable of compensating for the delay occurring in the share line 350.

The data driving block 300 of the touch screen liquid crystal display device in accordance with the present invention further includes a bias current supply section 313, which is connected to the share line output buffer 312, to increase a bias current, resulting in the reduction in the variation of the output waveforms. In addition, the bias current of the bias current supply section 313 can be adjusted by a control signal generated by a bias current control section (not shown).

Meanwhile, according to the data driving block 300 of the touch screen liquid crystal display device in accordance with the present invention, the share line multiplexer 322 has a size larger than that of the data line multiplexer 321, that is, resistance is further reduced, so that variation of output delay can be reduced.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A touch screen liquid crystal display device comprising:
a panel driving circuit including a gate driving block, a data driving block, and a signal control block; and
a liquid crystal module that stores data in data pixels through a data pixel line, to which the data pixels are connected, in response to a data signal applied from the data driving block, and reads data through a read pixel line to which read pixels are connected,
wherein the read pixels are connected to the data pixels through a share line.

2. The touch screen liquid crystal display device according to claim 1, wherein the data driving block includes:
an output buffer unit that outputs a data signal for driving the liquid crystal module;
a multiplexer unit that selects one of output signals of the output buffer unit and transmits the selected one to the liquid crystal module; and
a pad unit connected to the data pixel line and the share line of the liquid crystal module.

3. The touch screen liquid crystal display device according to claim 2, wherein the output buffer unit includes:
a data line output buffer that outputs the data signal to the data pixel line; and
a share line output buffer that outputs the data signal to the share line.

4. The touch screen liquid crystal display device according to claim 3, further including a bias current supply section that supplies the share line output buffer with a bias current.

5. The touch screen liquid crystal display device according to claim 4, further including a bias current control section that generates a signal for controlling the bias current.

6. The touch screen liquid crystal display device according to one of claims 3, wherein the multiplexer unit includes:
a data line multiplexer that selects and transmits one of output signals of the data line output buffer; and
a share line multiplexer that selects and transmits one of output signals of the share line output buffer.

7. The touch screen liquid crystal display device according to claim 6, wherein the share line multiplexer has a capacity larger than a capacity of the data line multiplexer.

8. The touch screen liquid crystal display device according to claim 6, wherein the multiplexer unit further includes a transmitter which is connected to an output terminal of the data line multiplexer and an output terminal of the share line multiplexer.
